(19) United States
(12) Patent Application Publication
(10) Pub. No.: US 2014/0189507 A1
(43) Pub. Date: Jul. 3, 2014

(54) SYSTEMS AND METHODS FOR CREATE AND ANIMATE STUDIO

(71) Applicants: Jaime Valente, Colonia, NJ (US); Isaac Ashkenazi, Rahway, NJ (US); Glenn Stafford, Flemington, NJ (US)

(72) Inventors: Jaime Valente, Colonia, NJ (US); Isaac Ashkenazi, Rahway, NJ (US); Glenn Stafford, Flemington, NJ (US)

(21) Appl. No.: 13/836,209

(22) Filed: Mar. 15, 2013

Related U.S. Application Data
(60) Provisional application No. 61/746,316, filed on Dec. 27, 2012.

(51) Int. Cl. G06F 3/0484

(52) U.S. Cl. CPC G06F 3/04845
USPC 715/705

(57) ABSTRACT

The present disclosure describes an interactive, educational toy for children. In some embodiments, the system is a tablet computer running an interactive software system. In some embodiments, the software system includes an assisted drawing module, a storyline builder module, a puzzle maker module, and a free canvas module. In other embodiments, additional features of the system are made available to a user by using a specialized tablet stylus.

### RELATED APPLICATION

This patent application claims the benefit of and priority to U.S. Non-provisional Application No. 61/746,316, entitled “Systems and Methods For Create and Animate Studio” and filed on Dec. 27, 2012, which is incorporated herein by reference in its entirety for all purposes.

A portion of the disclosure of this patent document contains material, which is subject to copyright protection. The copyright owner has no objection to the facsimile reproduction by anyone of the patent document or the patent disclosure, as it appears in the file or records of the Patent and Trademark Office, but otherwise reserves all copyright rights whatsoever.

### BACKGROUND OF THE DISCLOSURE

Children often play with creative, engaging toys. Often these toys are artistic in nature and can include drawing, coloring, or playing puzzles. Often these toys are difficult for children to make desired drawn characters and scenes with such characters.

### BRIEF SUMMARY OF THE DISCLOSURE

The present disclosure describes an interactive, educational toy for children. In some embodiments, the system may include an assisted drawing module, a puzzle maker module, storyline builder and/or a free canvas module. With the assisted drawing module, a user may learn to draw new characters or other images. The assisted drawing module provides the user with the unique feature of overlaying a dynamic grid onto the reference image. Using the dynamic grid as a reference, the user may draw the image square by square. In some embodiments, as the user zooms into the drawing area or reference area, the grid dynamically resizes. In other embodiments, a user may zoom into the reference image and the drawing area zooms to the same location in tandem. This feature may allow users to add fine detail to their drawings. The assisted drawing module may also overlay an assistance image into the drawing area that the user may trace.

In some embodiments, with the puzzle maker module, a user can put together custom and pre-built puzzles. The puzzle maker allows the user to create custom puzzles by incorporating images created with the other modules of the system and/or by custom drawing puzzle pieces over a selected image.

In other embodiments, the system includes a storyline builder module. The storyline builder module may allow the user to create, color, and animate the story panels. In yet other embodiments, the storyline builder may allow the user to incorporate images created with the assisted drawing module into the panels of the storyline builder.

In yet other embodiments, the system may include a free canvas module. With the free canvas module, the user may create active scenes with pre-built and custom drawn or created images. In some embodiments, the custom images are created with the assisted drawing module or other modules of the system. In yet other embodiments the systems may allow the user to add motion paths to the characters and images of a scene. The images and characters may zoom in, zoom out, and move about the scene along the motion path. The user may also add sound effects and speech to the scene.

According to one aspect of the disclosure, a method for assisting a user to draw includes providing, by a drawing assistance tool, a reference area that displays a reference image for a user to recreate in a drawing area. The drawing tool also provides a first grid overlaid onto the reference area such that the first grid is independently scalable of the reference image displayed in the reference area. The drawing tool further provides a drawing area that displays the drawing image, and a second grid overlaid onto the drawing area such that the second grid is independently scalable of the drawing area. The method further includes receiving a request to scale one of the first grid or the second grid, and providing the request to scale one of the first grid or the second grid to both the first grid and the second grid.

In some implementations, the method further includes receiving a request to scale one of the reference image or the drawing image. The request to scale one of the reference image or the drawing image can include a request to provide at least one of a pan, a rotate, a zoom in, and a zoom out manipulation.

In some implementations of the method, a plurality of cells of the first grid and a plurality of cells of the second grid maintain a specific size when the reference image or the drawing image is zoomed in or zoomed out. The method can further include providing the request to scale one of the reference image or the drawing image to both the reference image and the drawing image. The request to scale one of the reference image or the drawing image can include at least one of a pan, a rotate, a zoom in, and a zoom out manipulation.

In some implementations, the method includes providing a copy of the reference image in the drawing area. The copy of the reference image can be partially transparent.

In yet other implementations, the first grid and second grid are configured to temporally remain fixed in place, and the first and second drawing areas can be provided on a touch sensitive display.

According to another aspect of the disclosure, a device for assisted drawing includes a reference area that displays a reference image, and a first grid overlaid onto the reference area such that the first grid is independently scalable of the reference image. The system also includes a drawing area that displays a drawing image, and a second grid overlaid onto the drawing area such that the second grid is independently scalable of the drawing image, and wherein the first grid and the second grid are configured such that when one of the first grid or the second grid is manipulated both the first grid and the second grid are manipulated correspondingly.

In some implementations, the reference image and the drawing image are configured such that when one of the reference image or the drawing image is manipulated both the reference image and the drawing image are manipulated correspondingly.

In other implementations, a plurality of cells of the first grid and a plurality of cells of the second grid maintain a specific size when the reference image or the drawing image is zoomed in or zoomed out. In some implementations, the manipulation of the first grid or the second grid can include at least one of a pan, a rotate, a zoom in, and a zoom out manipulation.

In certain implementations, a copy of the reference image is displayed in the drawing area. The copy of the reference image can be partially transparent, and the copy of the reference image can maintain a location in the drawing area that is a same location the reference image maintains in the reference area. In some implementations, the second grid is configured to have a user selectable transparency level.

In yet other implementations, the first grid is configured to be reversibly locked into the position to the reference area and the second grid is configured to be reversibly locked into position relative to the drawing area. The device can include a touch sensitive display in some implementations.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein.

FIG. 2 is an embodiment of a system comprising an assisted drawing module, a storyline builder module, a puzzle maker module, and a free canvas module;

FIGS. 3A-B is an exemplary embodiment of a graphical user interface for interacting with the assisted drawing module of FIG. 2;

FIG. 3C is a flow chart of an exemplary method for assisting a user to draw; in accordance with an implementation of the present disclosure;

FIGS. 4A-D is an exemplary embodiment of a graphical user interface for interacting with the storyline builder module of FIG. 2;

FIGS. 5A-D is an exemplary embodiment of a graphical user interface for interacting with the puzzle maker module of FIG. 2;

FIGS. 6A-D is an exemplary embodiment of a graphical user interface for interacting with the free canvas module of FIG. 2;

FIG. 7 is an exemplary embodiment of an interactive stylus; and

FIG. 8 is a method for using a system comprising an assisted drawing module, a storyline builder module, a puzzle maker module, and a free canvas module.

### DETAILED DESCRIPTION

For purposes of reading the description of the various embodiments below, the following descriptions of the sections of the specification and their respective contents may be helpful:
Section A describes a network environment and computing environment, which may be useful for practicing embodiments described herein.
Section B describes embodiments of a system for an assisted drawing program.
Section C describes embodiments of system for a storyline builder program.
Section D describes embodiments of system for a puzzle maker program.
Section E describes embodiments of systems for a free canvas drawing program.
Section F describes embodiments of an interactive stylus.
Section G describes a method for using the system described herein.

### A. Computing and Network Environment

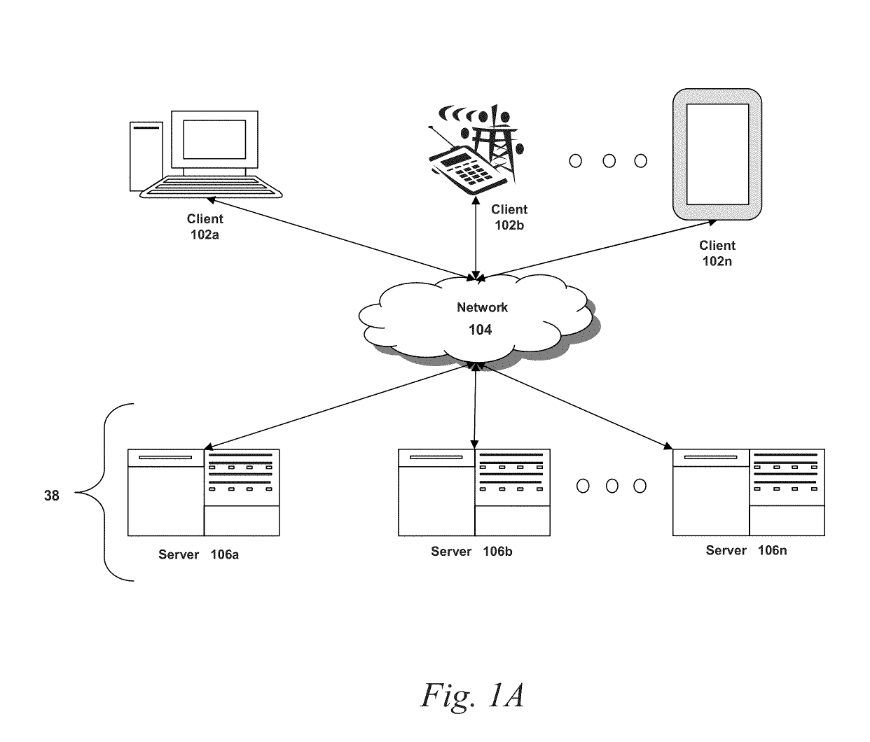

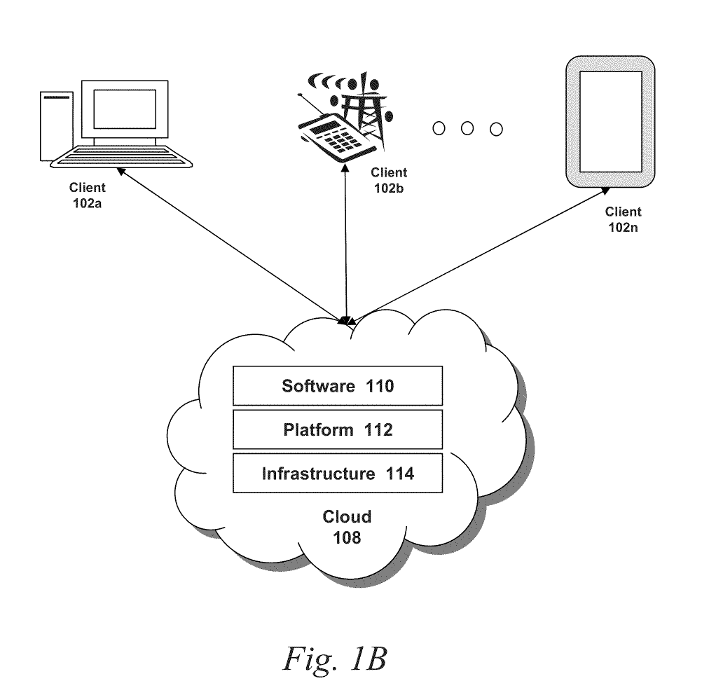

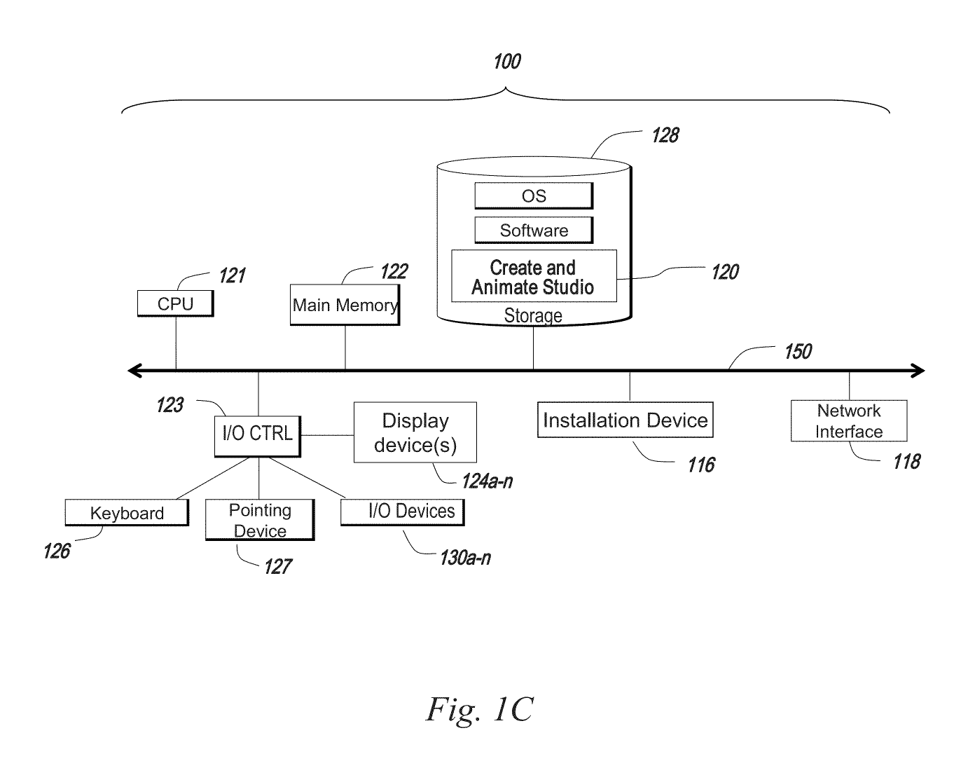

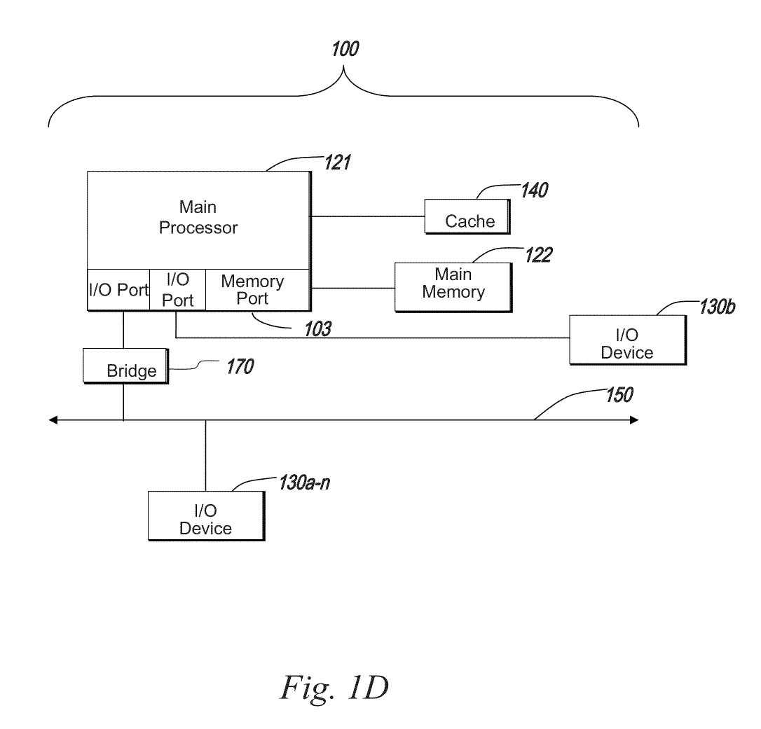

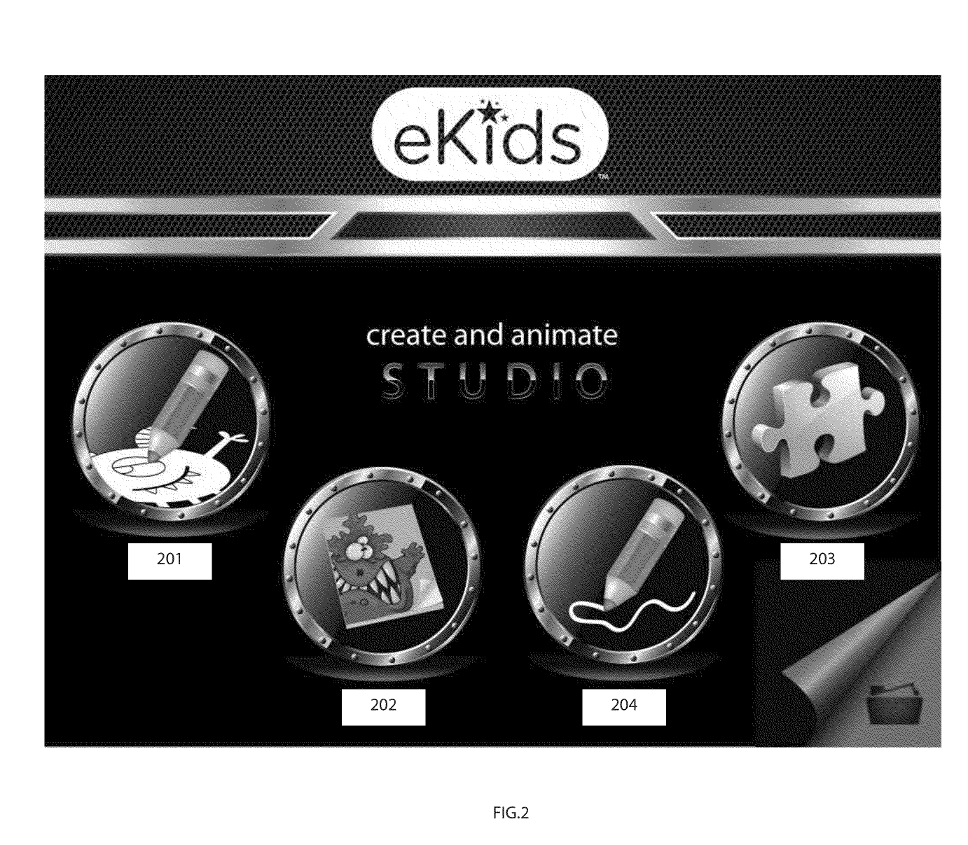

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network, which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP Internet protocol suite may include application layer, transport layer, Internet layer (including, e.g., IPv6), or the link layer. The network 104 may be a type of a broadcast network, a telecommunications network, a data communication network, or a computer network.

In some embodiments, the system may include multiple, logically grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allow more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud-computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and software of a create and animate studio 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition, which may be utilized as an input for different purposes including authentication and other commands. Some devices 130a-130n provide for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the experiment tracker system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as a installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

FIG. 2 illustrates one possible exemplary embodiment for the GUI 200 of the create and animate studio 120. In some embodiments the create and animate studio 120 includes a plurality of subprograms or modules. Discussed in greater detail below, but briefly, the create and animate studio 120 may include an assisted drawing module 201, a storyline builder module 202, a puzzle maker module 203, and a free canvas drawing module 204. These modules may be accessed by the GUI 200.

### B. Assisted Drawing Module

The assisted drawing module provides the user with a tool to easily draw characters and other images. Described in more detail below, but briefly, the graphical user interface GUI may be divided into a reference area and a drawing area. The image to be drawn may be displayed in the reference area as the user recreates the image in the drawing area. In some embodiments, a dynamic grid is overlaid on both the reference area and the drawing area, providing the user with additional points of reference. A user may zoom into one of the reference area or the drawing area, and the other area may automatically zoom into the same location in tandem. This may allow the user to easily add more detail to drawings.

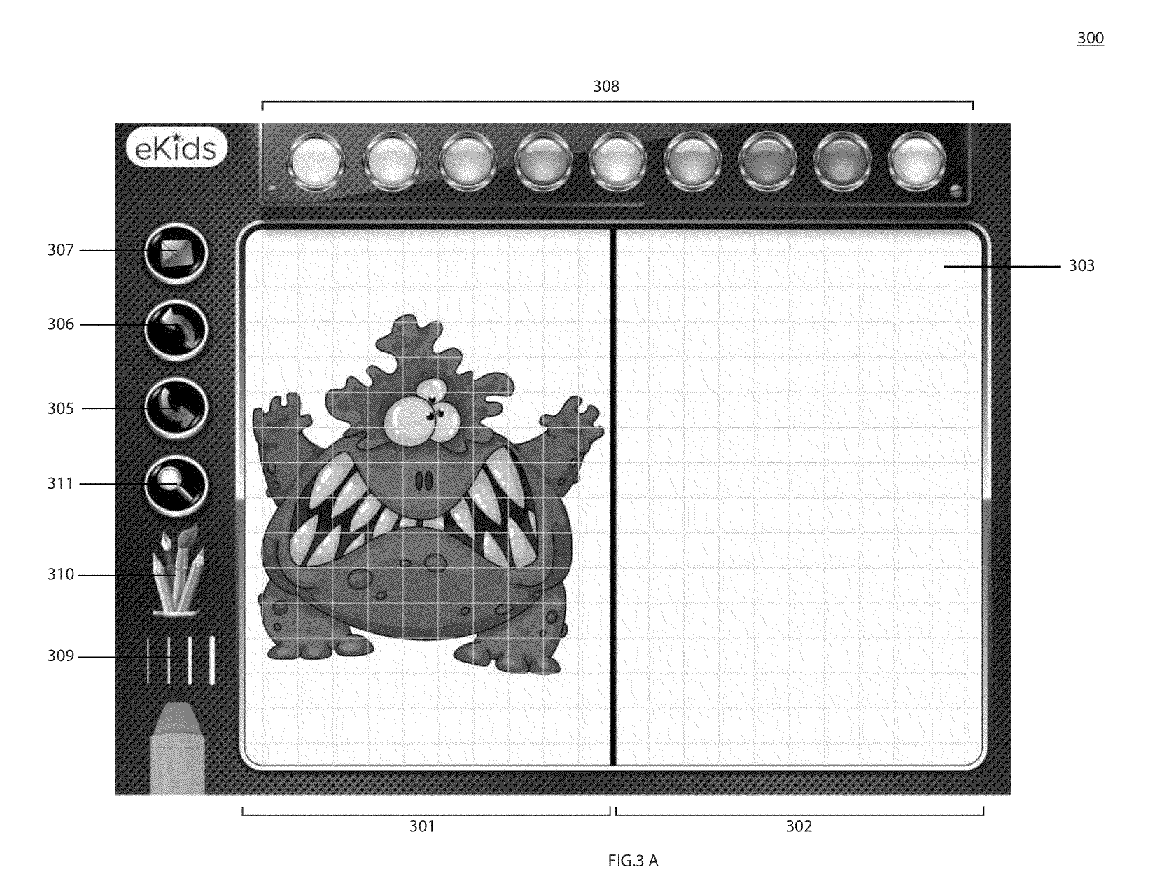

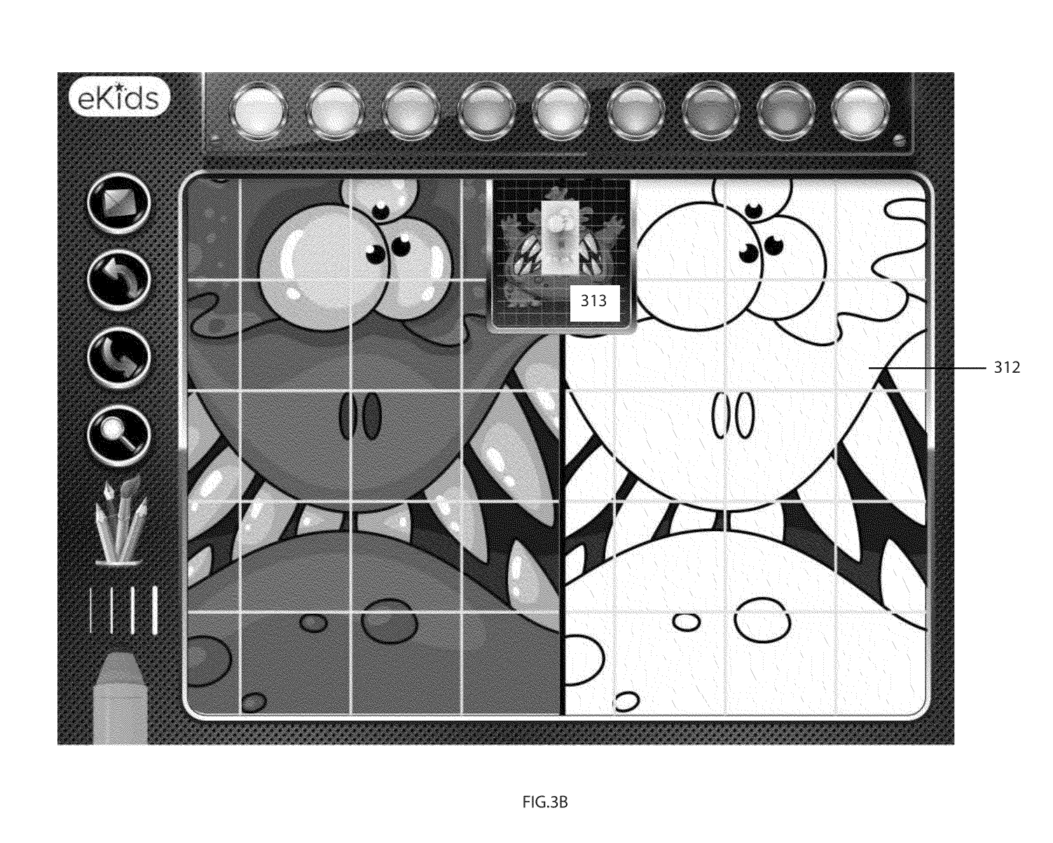

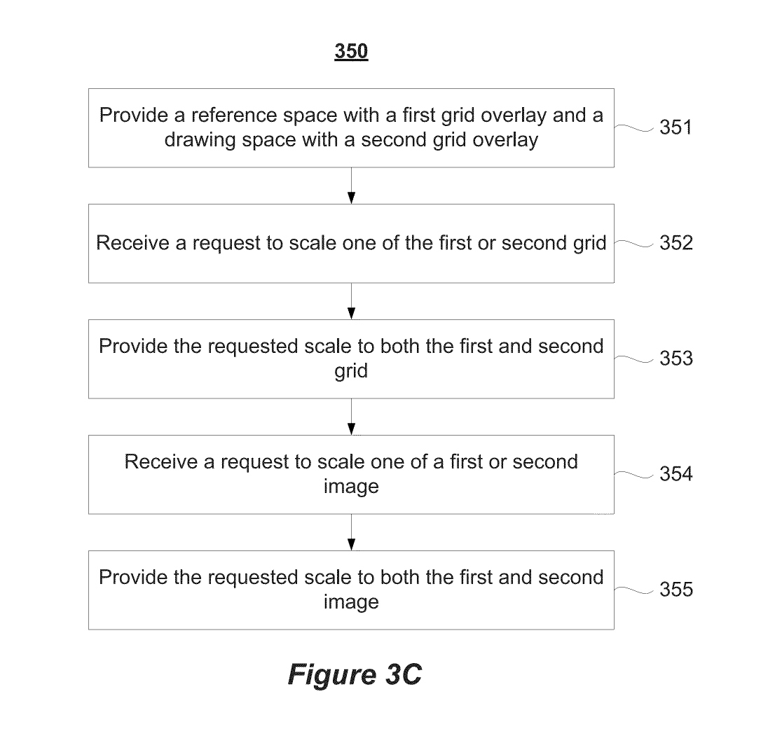

FIG. 3A is an exemplary GUI 300 of an assisted drawing module 201. In some embodiments the drawing portion of the GUI may be divided into a reference area 301 and a drawing area 302. The reference area 301 and drawing area 302 may include grid lines 303. The assisted drawing GUI 300 may also include a color palette 308, an undo button 306, a redo button 305, and a share button 307. A user may select different line thickness for the drawing tool with the thickness selector 309.

Still referring to FIG. 3A, and in greater detail, the assisted drawing GUI 300 includes a reference area 301 and a drawing area 302. The reference area 301 includes reference image the user can draw in the drawing area 302. The image in the reference area 301 can be any type of image, photo, or clip art. In some embodiments, the create and animate studio 120 allows the user to download additional images from the Internet, and in other embodiments the images are all preloaded in the create and animate studio 120. Responsive to starting the assisted drawing module 201, the user can select an image to draw. After selecting an image to draw, the user may attempt to draw the image in the drawing portion 302. In some embodiments, the user can use a stylus to draw the image. In other embodiments, the user can use his finger or other input device to draw the image.

The assisted drawing GUI 300 may also include a color palette 308. When drawing an image the user may select a specific color from the color palette 308. The lines the user draws can then be colored the specific color selected from the color palette 308. The assisted drawing GUI 300 can indicate to the user the currently selected color by activating a circle or other indicator around the selected color in the color palette 308.

Similarly, the assisted drawing GUI 300 may also include a tool palette 310. The tool palette 310 may provide the user with different drawing tools which the user may select. For example, the tool palette 310 may include a pen, pencil, marker, airbrush, color fill tool, eraser, and/or geometric shapes. In some embodiments, once selected the lines drawn by the user take on the characteristics of the selected tool. For example, the pencil tool may generate a fine line while the marker tool generates a wider line.

The assisted drawing GUI 300 may also include a number of buttons. For example, the assisted drawing GUI 300 may include a sharing button 307. Activating the sharing button may allow the user to send the image in the drawing portion 302 to a friend. For example, activation of the sharing button 307 may display a prompt allowing the user to email the image, post the image to Facebook or other social media website, tweet the image, or print the image.

In some embodiments, the assisted drawing GUI 300 also includes an undo 306 and redo 305 button. The undo button 306 may allow the user to remove the last drawn line. In some embodiments, the user may select the undo button 306 once for each line currently drawn on the drawing portion 302. In other embodiments, the user can only selected the undo button 306 a set number of times. For example, the user may only undo the last five lines drawn. Similarly, the redo button 305 adds back a line or other marking removed with the undo button 306.

The user may control the thickness of the drawing tool with the thickness selector 309. In some embodiments, selecting the thickness selector 309 may allow the user to select the desired thickness in pixels or select the size from predetermined sizes.

In some embodiments, the reference area 301 and the drawing area 302 include a grid pattern 303. The reference area grid and the drawing area grid can be overlaid on the images displayed in the reference area 301 and the drawing area 302 such that images displayed in the reference area 301 and the drawing area 302 do not obfuscate the grids displayed in the respective area. In some implementations, the create and animate studio 120 handles the components displayed in the reference area 301 and drawing area 302 in separate layers, or in a similar fashion, such that each component can be individually manipulated. For example, the reference area grid can be component that is scaled and panned separately than another component such as the reference area image. Furthering this example, the cells of the reference grid can be a set size and if a user zooms into (i.e., enlarges) the reference image the reference area grid can remain unchanged such that the cells of the reference grid remain the original-set size. Accordingly, in these examples the cell size remaining the same size while the reference image is enlarged results in additional grid lines being added to the reference image and/or drawing image. In some implementations, the additional grid lines further define the reference and/or drawing image. In some implementations, a user can select if a manipulation (e.g. zooming, panning, and rotating) should affect a grid layer or an image layer within the reference area 301 and/or drawing area 302. In some embodiments, the independent scalability of the grid layer and the image layer ensures a user cannot zoom into the image such that a single grid cell is larger than the displayed image and therefore not seen in the reference area 301 and/or drawing area 302. In some implementations, manipulations such as panning and rotating of an image or a grid are coupled to all layers of the reference area 301 and/or drawing area 302. For example, a user can zoom into the reference image of the reference area 301 and the create and animate studio 120 can leave the reference area grid unchanged. In this example, if the user pans the reference image and the create and animate studio 120 can apply the same panning manipulation to the reference area grid such that the reference grid and reference image pan in unison. In some implementations, a user can set the scale of the grid and image independently of one another and then lock the relationship between the grid and image.

As illustrated in FIG. 3B a user may zoom into a region of the reference area 301 or the drawing area 302. In some embodiments, the zoom and pan movements between the reference area 301 and the drawing area 302 are associated with one another. For example, if a user zooms into a square in the upper left hand corner of the reference area 301, the drawing area 302 will automatically be zoomed to the corresponding upper left hand portion of the drawing area 302. The user may manipulate the view of the drawing and/or reference area by using multitouch gestures. The multitouch gestures may include but are not limited to one or multifinger taps, one or multifinger double taps, long press, panning, flicking, spread to zoom in or pinch to zoom out. The user may use the multitouch gestures to slide the image around the viewing area, zoom into or out of the image, and/or rotate the image. In yet other embodiments, the assisted drawing GUI 300 may include buttons 311 that allow the user to zoom in, zoom out, and or rotate the images in the drawing and reference areas. In some embodiments, the user may lock the image into place, such that it can not be moved.

FIG. 3B also illustrates the independent scalability of the grid layer and the image layer. The zoom that translated the displayed image shown in FIG. 3A to the image displayed in FIG. 3B illustrates how the drawing and reference images can be scaled at a different rates relative to the drawing and reference grids. In some implementations, the relationship between the grids and images displayed in the reference are 301 and/or drawing are 302 are inputs from the user. For example, a user can select to which layer or display object the user would like the user manipulations to be applied. In another implementation, the create and animate studio 120 applies a transform to a manipulation applied in one layer before applying the manipulation to a second layer. For example, a user may zoom into the reference image, doubling its size. The create and animate studio 120 may apply a transformation to the user's manipulation such that the grid layer is only increased by 25%, and then apply the 25% increase manipulation to the grid layer. In some implementations, the create and animate studio 120 automatically increases the density of the grids relative to the detail shown in the reference image and/or drawing image to further define the reference and/or drawing images. In other implementations, the create and animate studio 102 may determine the relative size of a grid cell by analyzing the image onto which the grid is overlaid. For example, a user may zoom into a portion of the reference image that the create and animate studio determines to be complex. In this example, the create and animate studio 102 may automatically apply a grid with smaller cells than compared to a portion of the image that the create and animate studio 120 determines to be less complex. In some implementations, the create and animate studio 120 determines the complexity of a portion of an image responsive to an analysis of the image portion with an edge detection algorithm. In some embodiments the assisted drawing GUI 300 may include an image map 313. In some embodiments, the image map 313 is available to the user at all times. In other embodiments, the image map 313 is only available to the user when the user has zoomed into a portion of the image in the drawing area 302 or reference area 301. In some embodiments, the image map is a smaller image showing the entire reference area 301. The image map 313 may include an indicator 314 that indicates the portion of the reference area and/or drawing area the user is currently working. In some embodiments, as the user zooms, slides, or rotates the images of the reference area 301 and drawing area 302, the indicator 314 atomically updates to reflect the user's current view of the reference area 301 and drawing area 302.

In some embodiments the grid is a fixed square shape. In other embodiments the user may zoom in on an area in the drawing area 302 or the reference area 301 and the resolution of the grid 303 increases such that the grid 303 is always present on the screen. For example, in FIG. 3A the head of the character spans approximately 4 squares; however, as the user zooms in, FIG. 3B shows the character's head spans at least 20 squares. In some embodiments, grid is an overlay applied to the image and not a portion of the image itself, such that the grid is not affected when the user zooms into the image. In other embodiments, the grid may be under laid below the image.

In some embodiments, the assisted drawing GUI 300 provides an assistance image 312 to the user. The assistance image 312 may be the same image as the reference image. In some embodiments, the occupancy of the assistance image is low such that it a user can easily draw over the assistance image 312.

In some embodiments, the user may zoom into the reference area 301 to see additional details of the reference image. For example, the reference and drawing images may be vector images, or other such images, that reveal additional details of the image as the user zooms into the image. In other embodiments, the user may zoom into the drawing area 302 to add additional details to the image the user is currently drawing. For example, when drawing the eyes of a character the user may zoom into the area the user wishes to draw the eyes. In yet other embodiments, the user may zoom into the assistance image 312 to reveal additional details the user may draw in the drawing area 302.

In some embodiments, the user may save the drawn image incrementally during the drawing process. For example, a user may save the image after completing a specific portion of the drawing, such as the outline of a character, after drawing a rough sketch of an image, or before coloring the image. In some embodiments, the user may revert back to these saved drawings at a later time.

FIG. 3C is a flow chart of a method 350 for assisting a user to draw. At step 351, the create and animate studio 120 provides a reference space 301 with a first grid overlay and a drawing space with a second grid overlay to the user. The create and animate studio 120 can also provide a reference image in the reference space 301, which the user draws as a drawing image in the drawing space. As described above, the images and grids in a respective space can be independently manipulated or manipulated together.

At step 352, the create and animate studio 120 receives a request to scale one of the first or second grids. In some implementations, the request can be received as a touch input on a client device 102 with a touch sensitive screen. The request can be a multitouch gesture that can include but is not limited to one or multifinger taps, one or multifinger double taps, long press, panning, flicking, spread to zoom in or pinch to zoom out. In another implementations, the input can be received from an input device 130 (e.g. a mouse).

At step 353, the requested scale is provided to both the first and second grid. As illustrated in FIGS. 3A and 3B, the user is provided a drawings space 302 in which to recreate the reference image. By providing the requested scale to both the first and second grids, the create and animate studio 120 ensures the grids displayed to the user in both the reference space 301 and the drawing space 302 are identical. In some implementations, when providing the requested scale to both the first and second grid, the scale is not provided to the reference and drawing image.

At step 354, the create and animate studio 120 receives a request to scale one of the reference image and the drawing image. In some implementations, the request can be received as a touch input on a client device 102 with a touch sensitive screen. The request can be a multitouch gesture that can include but is not limited to one or multifinger taps, one or multifinger double taps, long press, panning, flicking, spread to zoom in or pinch to zoom out. In another implementations, the input can be received from an input device 130 (e.g. a mouse).

At step 354, the requested scale to one of the reference image and the drawing image is provided to both the reference image and the drawing image. Similar to step 353 described above, providing the requested scale to both the reference image and the drawing image, ensures the images displayed to the user in both the reference space 301 and the drawing space 302 have the same proportions and relative positioning. In some implementations, when providing the requested scale to both the reference image and the drawing image the scale is not provided to the first and second grids.

C. Storyline builder Module

In some embodiments, using the storyline builder GUI 400, the user may create and animate numerous storylines with the storyline builder module. In some embodiments, these storylines include a single panel drawing, multiple single panel drawings, and in other embodiments the storylines may include multiple multi-panel drawings. Before or after adding images to the panels of the storyline, the user may color and animate the panels.

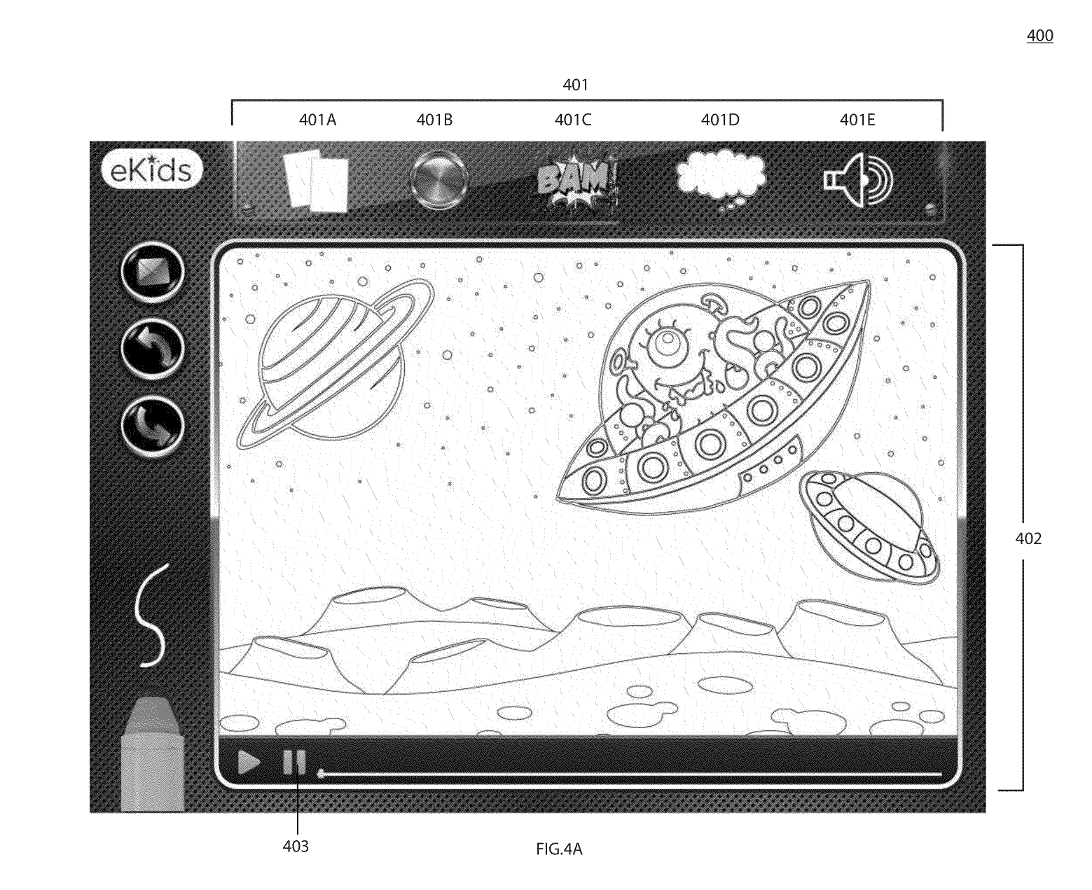

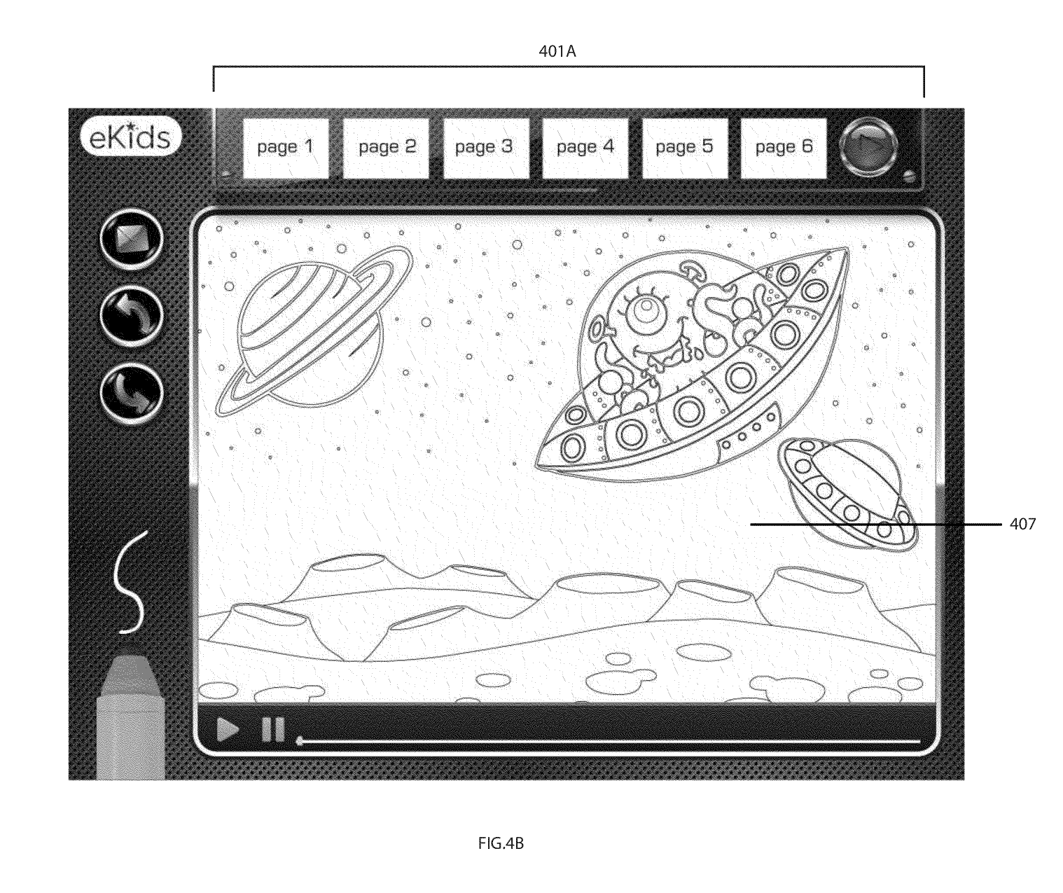

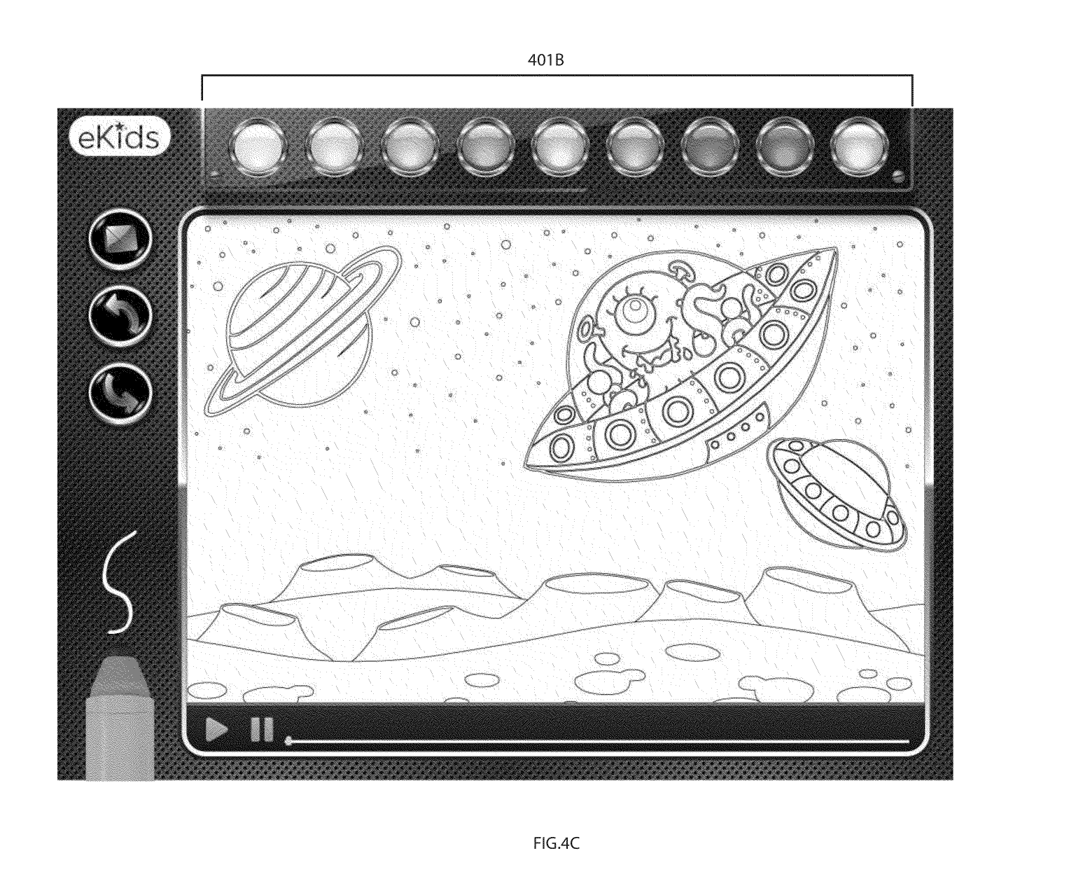

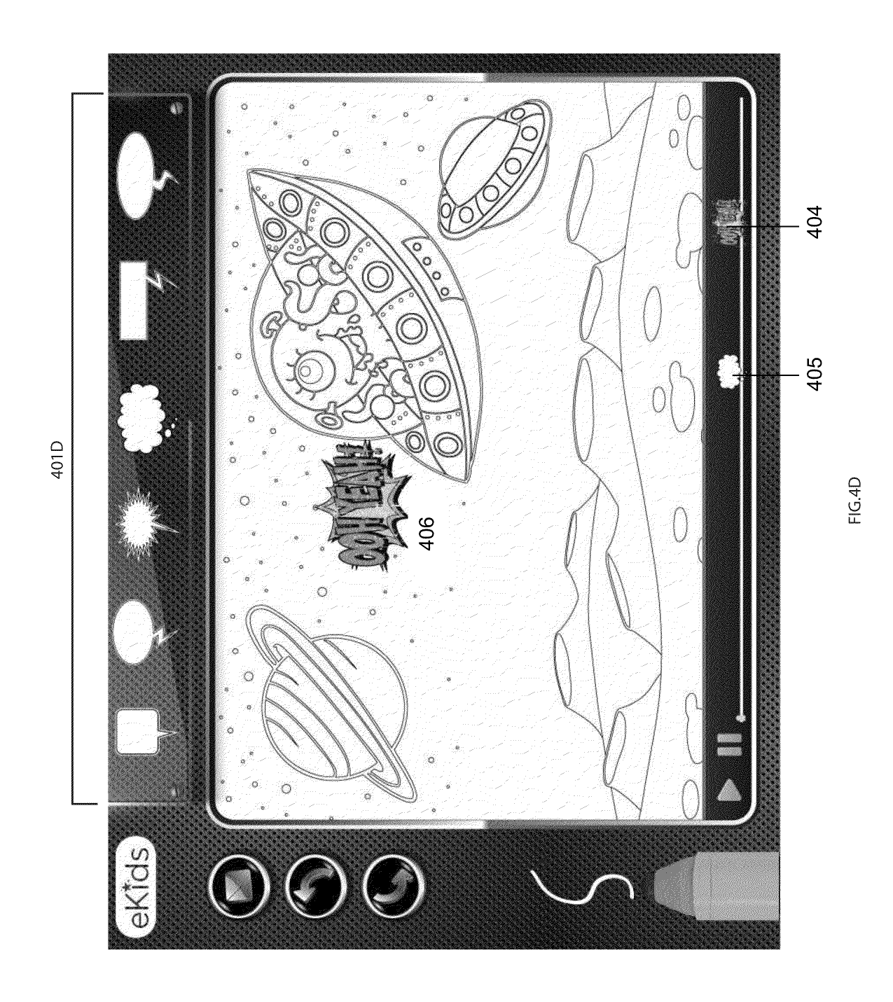

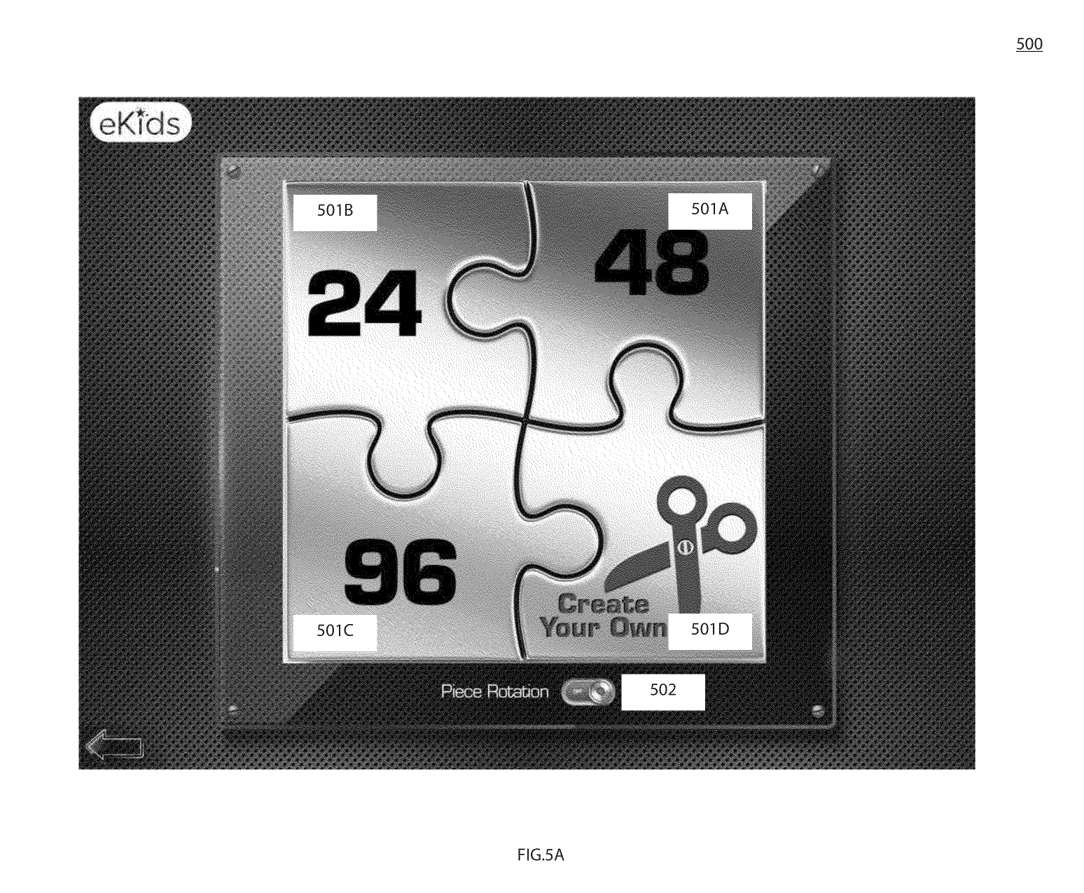

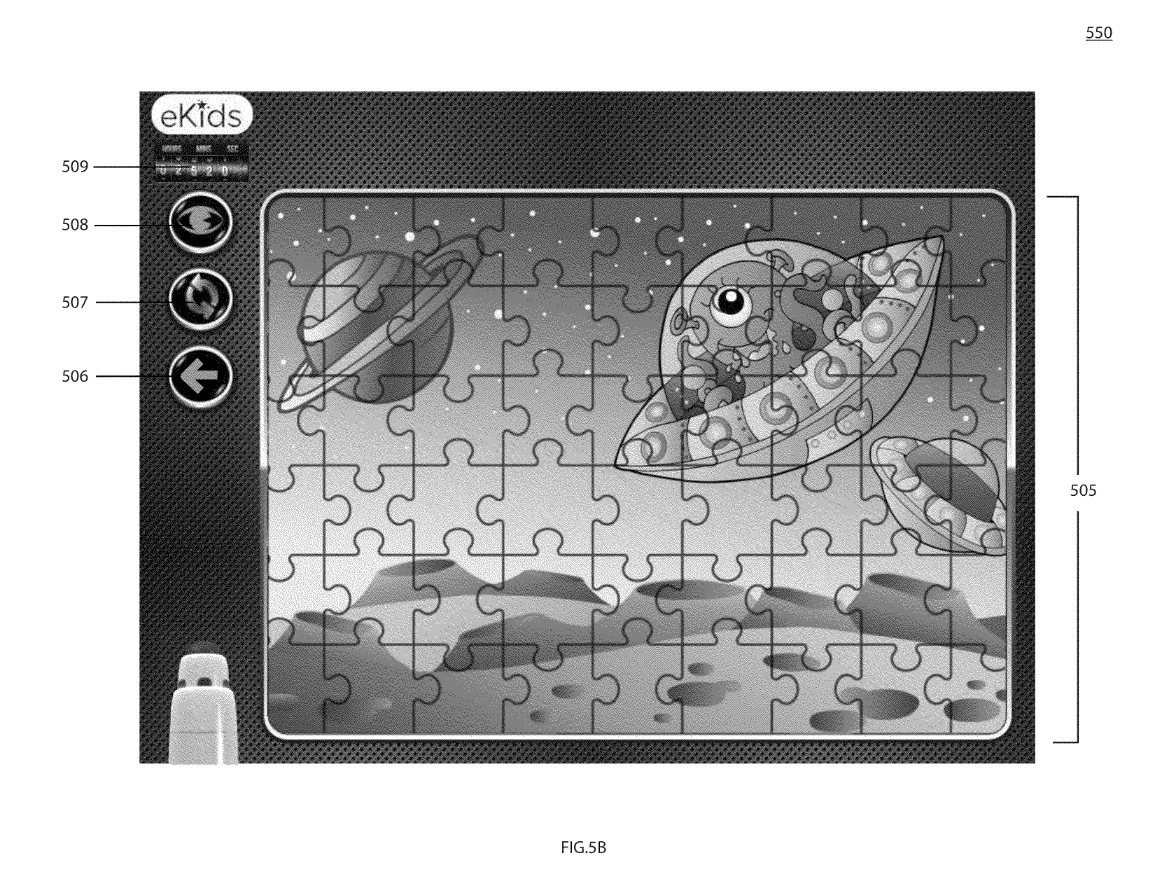

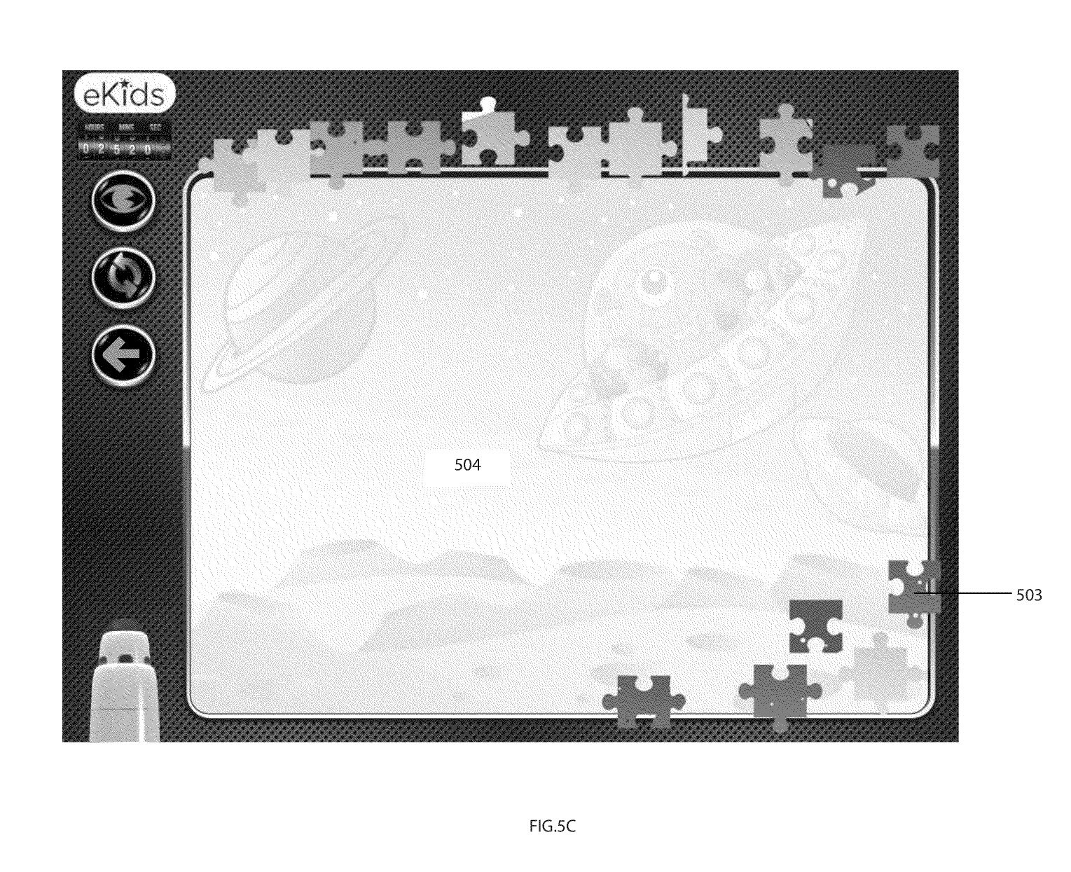

FIG. 4A is an exemplary embodiment of a storyline builder module GUI 400. The storyline builder module GUI may include some of the previously described features such as a share button, an undo button, and a redo button. The storyline builder module may also include a resource palette 401 that may include a number of sub-palettes 401A-E. In some embodiments, the sub-palettes 401A-E include categorized resources the user may add to the storyline. The user may select items from the palettes and add them to the panel of the storyline currently in the workspace 402. In some embodiments, these may include a panel palette 401A, colors palette 401B, and various sound effect palettes 401C-E. In other embodiments, the storyline builder module GUI 400 may also include a timeline 403.

Referring to FIG. 4B, if a user activates the panel palette 401A, the storyline builder GUI 400 may display to the user a number of available panels. Each panel may include one or more images. In some embodiments the images are preselected to go with each panel, and in other embodiments the user may select the images that are associated with each panel. In some embodiments, the panels may be single or multi-framed images.

Still referring to FIG. 4B, using the panel palette 401A, the user may select a first panel image 407. The panels may include black and white images 407, which the user may animate, color, or add other effects thereto. In other embodiments, the user may select images previously created with the assisted drawing module 201. For example, the user may create an image with the assisted drawing module 201, and save the created image. The user may then add the created image to a panel with the storyline builder module GUI 400.

Responsive to selecting a panel image 407, the user may color the image using colors available in the color palette 401B. FIG. 4C illustrates an exemplary embodiment of the storyline builder GUI 400 displaying the color palette 401B. After selecting the color palette 401B, a full color palette may be displayed to the user. In some embodiments, the storyline builder GUI 400 allows the user to customize the colors presented in the color palette 401B, and in other embodiments the colors are pre-set and may not be altered. Similar to the assisted drawing GUI discussed above, the storyline builder module GUI 400 may also include a tool palette. When selected, the tool palette may display to the user a plurality of available tools.

FIG. 4D illustrates the sound palettes in greater detail. In some embodiments, the action words palette 401C, speech bubbles palette 401D, and effects palette 401E may be displayed as separate palettes. In other embodiments the action words palette 401C, speech bubbles palette 401B, and effect palette 401E may be included in a combined palette. In some embodiments, the action words 401C and speech bubbles 401B have graphical representations that are placed onto the workspace 402. For example, the action word BAM! 406 was placed into the workspace 402. Additionally, sound effects may be placed into the workspace 402 at specific temporal locations in the panel. In some embodiment, adding a sound effect to the workspace 402 also adds a representation of the sound effect to the timeline 403. For example, the previously placed BAM! was inserted into the timeline at point 404. In some embodiments, the BAM! 406 sound effect and corresponding image will not appear when the storyline is played back until the story line reaches the point 404. Additionally, FIG. 4D illustrates that a speech bubble has been placed at time point 405. In some embodiments, when a user adds a sound effect to the storyline it is automatically placed in the correct location in the timeline 403. In some embodiments, the user may move the sound effect to different locations in the timeline 403. For example, the user may intentionally cause the sounds to be out of order with the images of the storyline. In yet other embodiments, the user may add duplicate sound effect to a timeline 403.

Action words 406 are graphical representations of words. In some embodiments, the action words 406 are onomatopoeic words. Example action words can include, but are not limited to BANG, WOW, BOOM, BAM, and POW. In some embodiments the sound that accompanies these onomatopoeic words is the sound imitated or suggested by the word.

In some embodiments, the speech bubbles include predefined text, and are accompanied by the speech of an actor speaking that predefined text. In other embodiments, the user may insert custom text into the speech bubbles and the text is synthesized when the user plays the storyline.

### D. Puzzle Maker Module

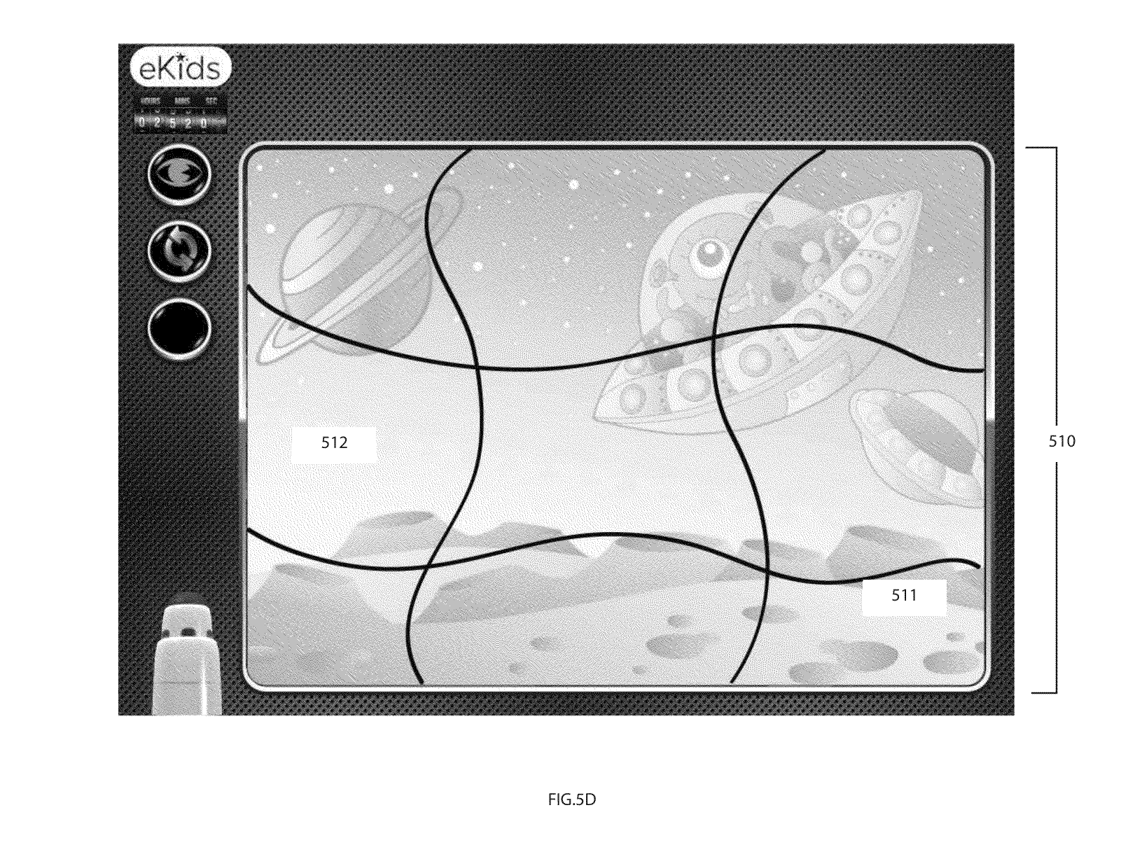

As described above, in some embodiments the create and animate studio 120 may include a puzzle maker module 203. FIG. 5A is an exemplary embodiment of the puzzle maker GUI's first screen 500. In some embodiments, the first screen of the puzzle maker GUI 500 is a difficulty and options selector. The selector screen may allow the user to select the number of pieces the puzzle will have. For example, as illustrated in the first screen 500, the user may be able to select 24, 48, or 96 pieces. In some embodiments the user may enter a custom number of pieces. Discussed in greater detail below, but briefly, in some embodiments the user may elect to create a custom puzzle by selecting the “Create Your Own” button 510. In some embodiments, the first screen of the puzzle maker GUI 500 may also have a puzzle rotation option 502. When the puzzle rotation option 502 is off, when the puzzle pieces are later scrambled before game play, they will maintain their correct orientation. Conversely, when the puzzle rotation option 502 is on, the pieces may not maintain their correct orientation after being scrambled.

FIG. 5B is an exemplary embodiment of the puzzle screen 550 of the puzzle maker GUI. The puzzle screen 550 is displayed to the user responsive to the user selecting a difficulty level and options on the first page of the puzzle maker GUI 500. In some embodiments, the puzzle screen displays a completed puzzle in the puzzle area 505 to the user prior to scrambling the puzzle.

Adjacent to the puzzle screen area 505 the puzzle GUI may contain a number of user options. For example, the puzzle screen 550 includes a back button 506 that allows the user to return to the previous screen of the GUI. The puzzle screen 550 also includes a re-scramble 507 button that may allow the user to further or re-scramble the puzzle pieces. The hint button 508 may provide the user with a hint about the puzzle or a view of the completed puzzle. In some embodiments, the puzzle screen 550 may also include a timer 509 to time how long it takes the user to complete the puzzle.

FIG. 5C illustrates the puzzle GUI 550 responsive to the user scrambling the puzzle. In some embodiments, the user may scramble the screen by shaking the tablet device, pressing a button on the screen of the puzzle GUI 550 or by clicking a button on a mouse or stylus. Responsive to being scrambled, the puzzle pieces 503 are randomly placed around the screen. As described above, the user may select for puzzle GUI 550 to provide a hint to the user. One example of a hint is for the puzzle GUI 550 displaying a low transparency image 504 of the completed puzzle in the puzzle screen area 505. Other hints may include automatically placing a puzzle piece 503 in the correct location in the puzzle screen area 505, indicating to the user a specific quadrant a selected puzzle piece 503 is located in the completed puzzle, or sorting the puzzle pieces by feature such as being an edge or corner piece.

FIG. 5D illustrates the previously discussed, “Create Your Own” option. Responsive to selecting the “Create Your Own” button 501D, the user is presented with an image 510 in the puzzle area 505. Using a stylus, finger, mouse, or other input device, the user may draw lines 511 on the image 510 to create custom puzzle pieces 512. In some embodiments, there is no restriction on the number of lines or shapes the user can use to create custom puzzle pieces 512. After drawing a plurality of lines 511 on the image 510, the create and animate studio 120 may transform the closed shapes into custom puzzle pieces 512. Similar to the example given above, the user may scramble the screen by shaking the tablet device, pressing a button on the screen of the puzzle GUI 550 or by clicking a button on a mouse or stylus. In other embodiments, the “Create Your Own” button 501D may allow the user to add custom images to be converted into a puzzle. The images may be images the user downloaded from the internet or the images may be images the user created with other modules of the create and animate studio 120. In some of these embodiments, custom image puzzle may also include custom puzzle piece shapes created by the user. In yet other embodiments, the user may allow the create and animate studio 120 to divide the image into the standard puzzle pieces as described above.

### E. Free Canvas Module

As described above, in some embodiments the create and animate studio 120 may include a free canvas module. With the free canvas module, the user may draw and color their own creations, create scenes with images created with the other modules of the create and animate studio 120 and stock images. The user may add backgrounds and characters to the scene. After adding characters and other elements to the scene, the user may bring the scene to life by adding sound effects to the scenes and animating the characters.

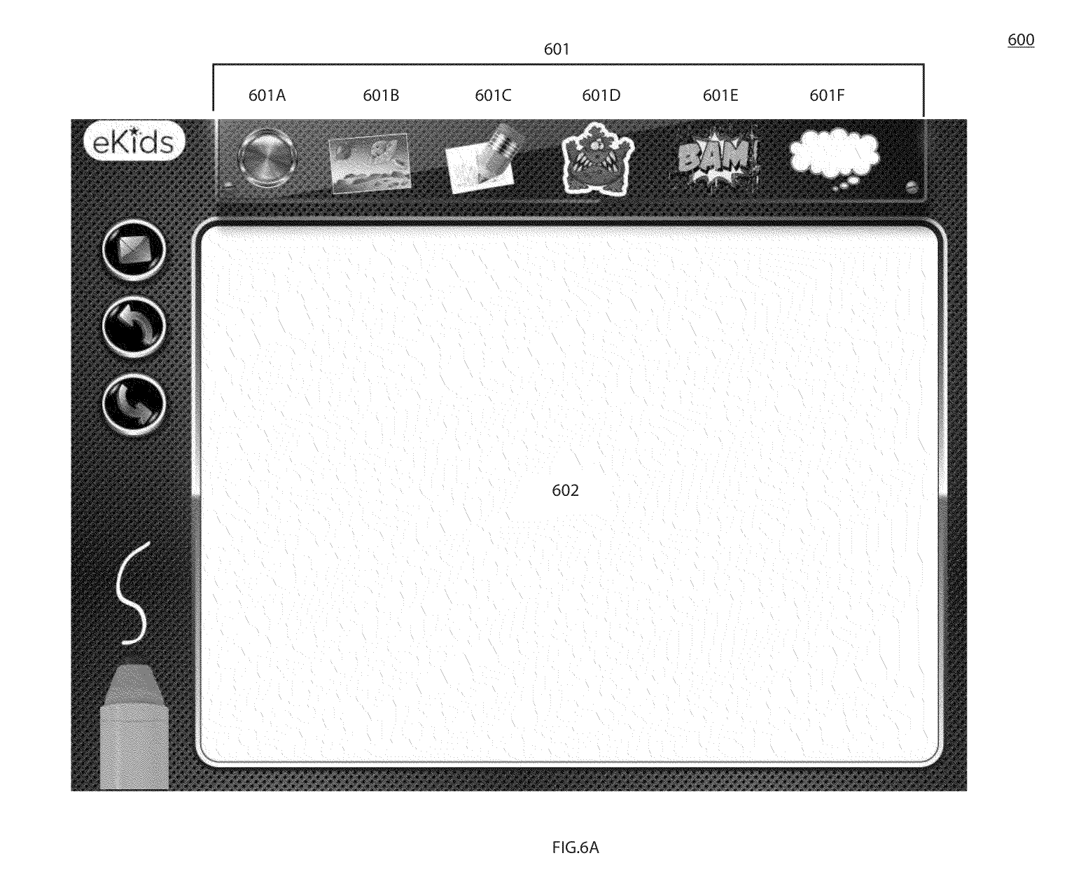

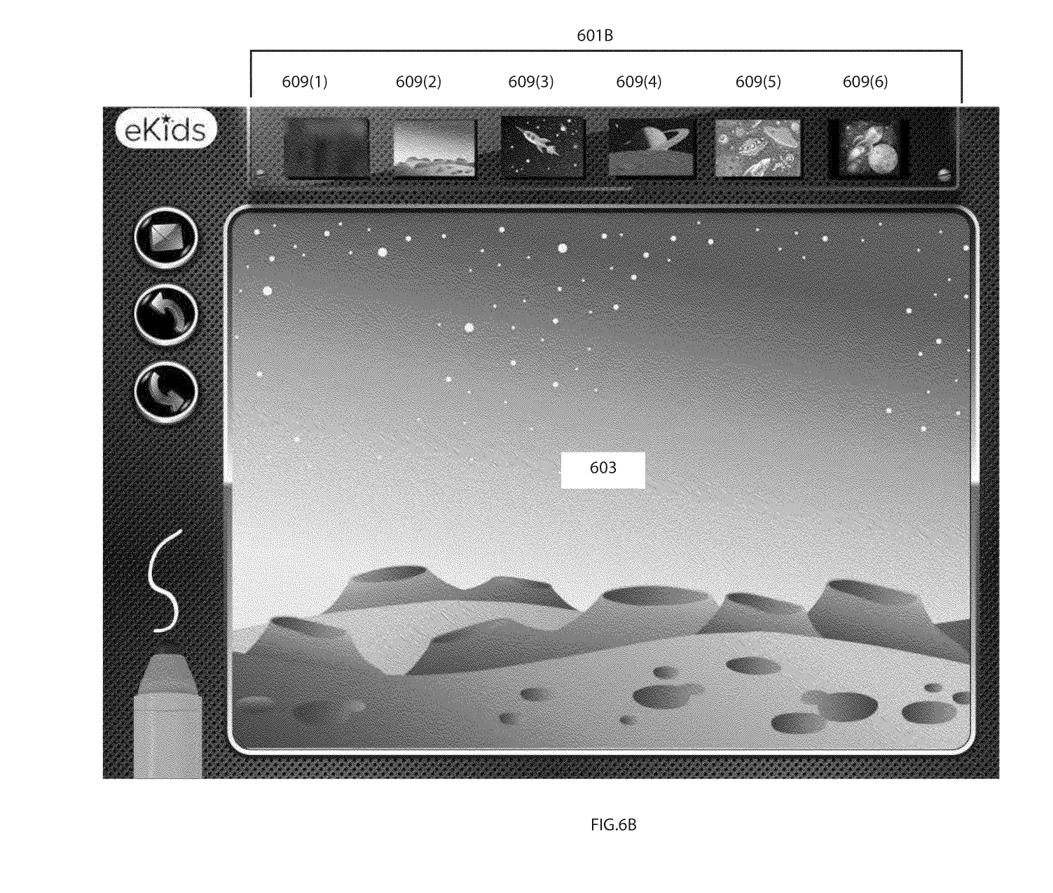

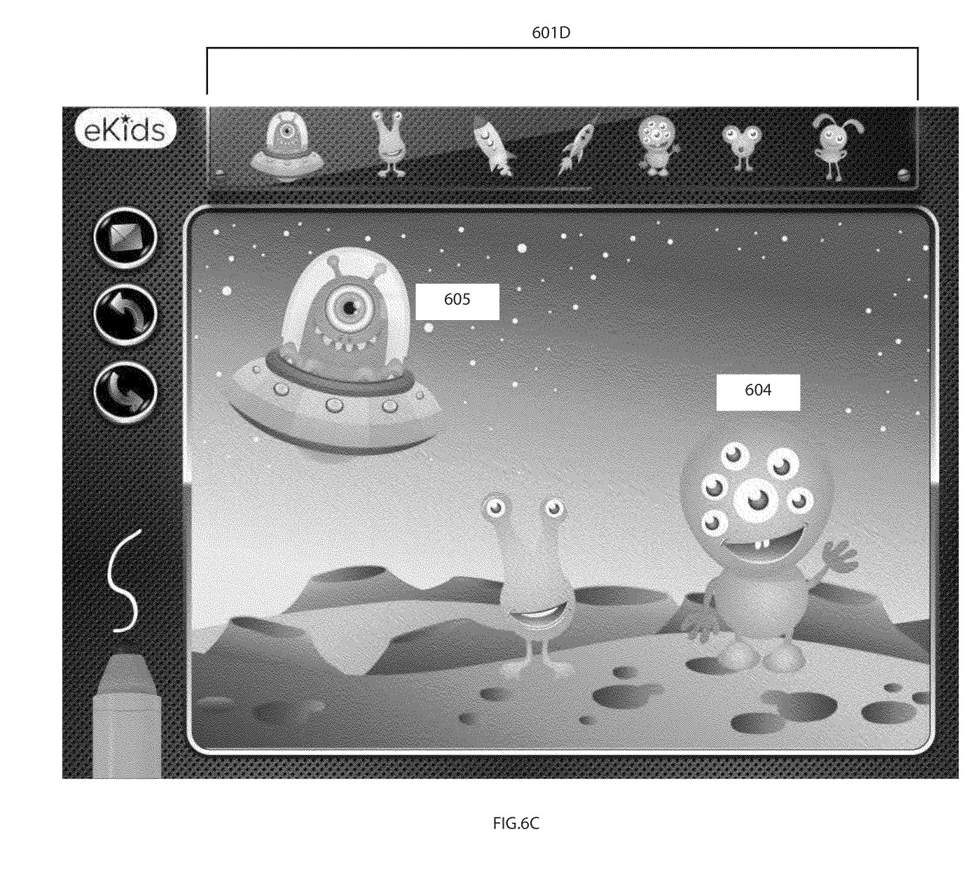

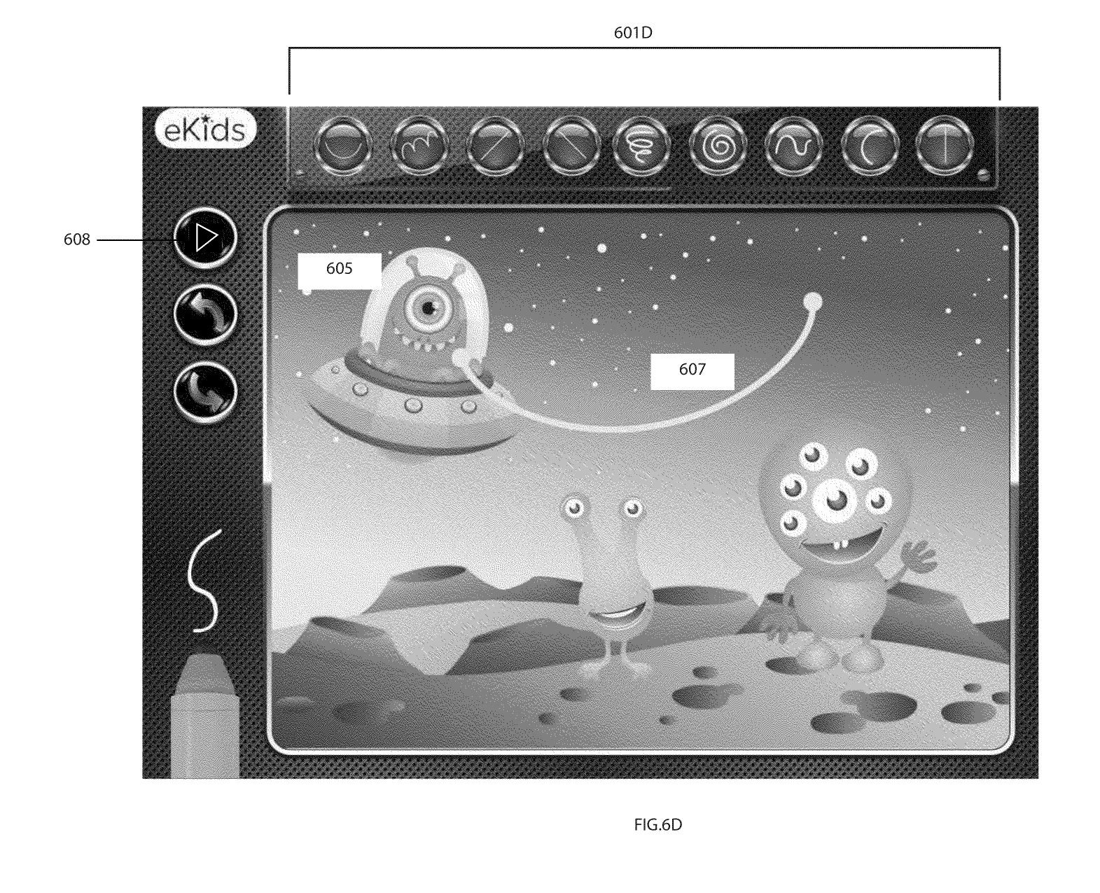

FIG. 6A is an exemplary embodiment of the free canvas mode GUI 600. The free canvas mode GUI 600 includes a drawing workspace 602. The user may add items to the workspace 602 from the palette toolbar 601 or draw in the workspace 602 with an input device. Described in greater detail below, the palette toolbar 601 may include a number of sub-palette toolbars. For example, these may include a color palette 601A, a background palette 601B, a library palette 601C, a clip-art palette 601D, an action word palette 601E, and a speech bubble palette 601F.

In some embodiments, each of the palettes works similarly to the above described palettes and sub-palette toolbars. For example, each palette displays to the user a collection of items the user may insert into the workspace 602. In some embodiments, the only difference between the palettes may be the category of content they display to the user. For example, the background palette 601B displays available backgrounds to the user, while the library palette 601C shows the user sketches and other artwork the user previously created.

FIG. 6B provides an exemplary embodiment of the free canvas mode GUI 600 responsive to selecting the background palette 601B. Once selected, the background palette 601B displays a number of available backgrounds 609(1)-(6) to the user. In some embodiments, the user may download additional backgrounds from the Internet or create custom backgrounds. Selecting an image from the background pallet, the user inserts and scales and/or rotates the background 603 into the workspace 602.

FIG. 6C is an exemplary embodiment of the free canvas mode GUI 600 displaying the clip-art palette 601D. Similar to above, in some embodiments, the user may select an image from the clip-art palette 601D and insert the image 605 into the workspace 602. The user may insert items from multiple palettes into the workspace 602. In other embodiments the user may include an image 604 the user previously created. The user may have created the image 604 with the assisted drawing module 201 or the image 604 may be a panel from the storyline builder module 202. In some embodiments, when inserting an image into the workspace 604, the user may increase or decrease the size and/or the orientation of the selected image.

In some embodiments, similar to the storyline builder module discussed above, the free canvas mode GUI 600 may have a timeline at the bottom of the workspace. The user may associate the images and sounds from the palette with specific points in the timeline. When played back the various images and sounds inserted into the workspace may appear according to their location in the timeline.

In some embodiments, in addition to having sounds and image appear at specific times, the user may also create motion paths along which the inserted images move. FIG. 6D illustrates an exemplary embodiment of motion path palette 606 for inserting motion paths 607. In some embodiments, the motion path palette 606 may become available to the user responsive to the user inserting a clip art image 605 or previously created image 604 into the workspace 602. In some embodiments, the user may later animate the images of the workspace. For example, in the exemplary embodiment of FIG. 6D, a motion path 607 has been placed on the clip-art image 605. In this example, the motion path directs the clip-art image 605 from the background of the workspace to the foreground. The motion path may disappear from the workspace 602, when the user clicks the play button 608. In some embodiments, responsive to the user selecting the play button 608, create and animate studio 120 begins to play the animation by moving images into and out of the workspace 602 based on their position in the timeline. In some embodiments, the motion paths may also be accompanied by zooming in or zooming out of the images to facilitate to the effect of the image moving around the workspace. For example, an inserted image may enlarge as it moves along a motion path 607 that takes it from the background of the workspace to the foreground. In some embodiments, the user may draw custom motion paths with a stylus or other input device.

### F. Interactive Stylus

In some embodiments, some of the features described above are “unlocked” by an in-store purchase or the purchase of additional hardware. For example, the motion path palette 606 may only be made available to the user if the user has purchased and paired an interactive stylus with the tablet device running the create and animate studio.

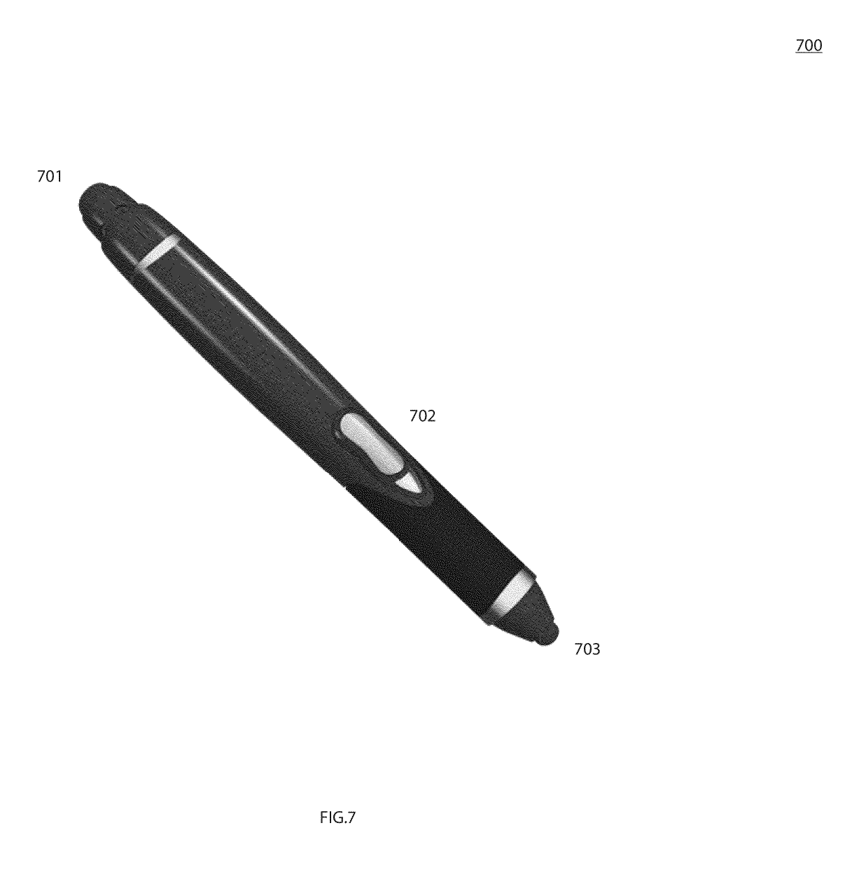

FIG. 7 is an exemplary embodiment of an interactive stylus 700. In some embodiments, the interactive stylus 700 may include a toggle button 702 and a writing end 703. As described above, the interactive stylus 700 may make additional features of the create and animate studio 120 available to the user or provide the user with application specific functions.

In some embodiments, the toggle button 702 may allow the user to adjust the thickness of a drawing line. In other embodiments, the toggle button 702 may let the user enlarge or decrease the size of an image the user added to a scene or panel. The toggle button may also rotate images or puzzle pieces. In other embodiments, the toggle button 702 may change the function of the stylus. For example, clicking the toggle button 702 may allow the user to change the function of the stylus to an ink pen, a marker, a watercolor brush, an airbrush, a paint bucket, a blending tool, a stamp, or a shading tool. In other embodiments, clicking toggle button 702 may adjust the sort order of added images or adjust the timing of objects along the timeline of the story builder GUI 400 and the free canvas GUI 600. In other embodiments, clicking the toggle button 702 may provide the user with a hint. For example, clicking the toggle button 702 may find a puzzle piece for a specific location when the user is using the puzzle maker module 203. In some embodiments, the toggle button 702 may be used as an input for the assisted drawing GUI 300. For example, the toggle button 702 may be used to zoom into the reference 301 or drawing area 302. In other embodiments, the toggle button 702 may be used to increase or decrease the size of the space between the grid lines 303 of the assisted drawing GUI 300.

In yet other embodiments, the interactive stylus 700 includes an accelerometer or other means for detect shaking or movement of the stylus 700. In some embodiments, shaking the stylus 700 reveals special features of the create and animate studio 120. For example, shaking the stylus 700 when the user is using the assisted drawing module 201 may reveal the assistance image 312 described above. In the story builder module 202, shaking the stylus 700 may reveal extra 3D effects that may be added to a scene. In the puzzle make module 203, shaking the stylus 700 may provide the user with a hint to the correct location of a puzzle piece. Shaking the stylus 700 while using the free canvas module 204 may reveal the path palette 606 described above.

### G. Method for Using the Create and Animate Studio

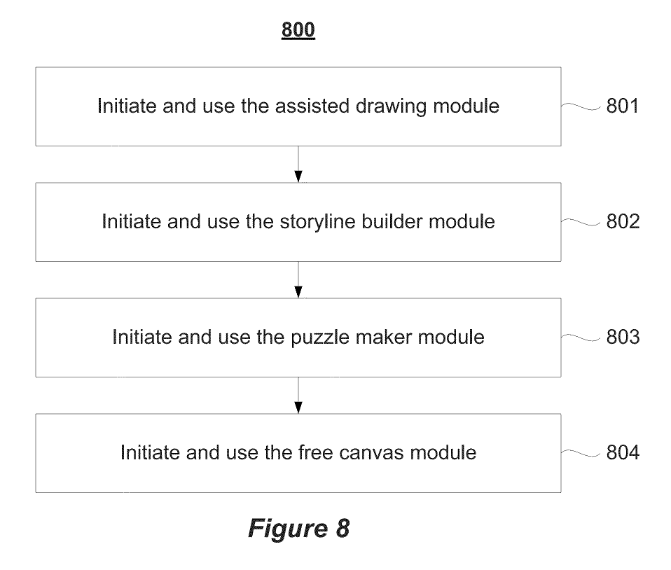

FIG. 8 is a flow chart of a method 800 for using a create and animate studio. The skilled artisan will understand that, although the method steps above are shown in a particular order, they can be done in any order, or certain steps may be skipped entirely. At step 801, a user initiates and uses the assisted drawing module. In some implementations, when the create and animate studio 120 is initialized the user is presented with a home screen. The home screen can provide, via a GUI, a means for the user to initiate each of the modules described herein. For example, as illustrated in FIG. 2, a user can select a button on the create and animate home page that initiates each of the modules. As described above, when using the assisted drawing module, a user can draw in the drawing space 302 the image displayed in the reference space 301. In some implementations, the image displayed in the reference space can come preinstalled with the create and animate studio software. In some implementations, the user can insert into the reference space 301 custom images they would like assistance drawing. In using the assisted drawing module, the user can use a plurality of multitouch gestures to move and manipulate the reference image, drawing image, or grid overlays. The user can also use the multitouch gestures to zoom into specific portions of an image to see (in the case of zooming into the reference image) or to draw (in the case of zooming into the drawing image) additional details in the image. In some implementations, the user can save their created drawing. In some implementations, the saved drawing can be further modified at a later date and/or used by the other modules of the create and animate studio 120.

At step 802, the user initiates and uses the storyline builder module. As described above, the user can initiate the storyline builder module from the home screen of the create and animate studio. When using the storyline builder module, the user can animate and add media to pre-installed or custom storylines. As described above in relation to Section C, using the storyline builder module the user can add color, sound, word art, and other media to a plurality of storyboards. The user can add the media to specific locations in the timeline of the storyboard. Responsive to creating adding media to the story board, the user can play back the created story board. When using the device in playback mode, the storyline builder module may contain a play button, which the user can select to begin the playback session. In some implementations, the storyline builder module can allow a user to save their created storyline. In some implementations, the storyline is saved such that it can be later edited by the create and animate studio 120. In certain implementations, user can export the created storyline as a series of images, video, and/or audio media for playback and use with other systems.

At step 803, the user initiates and uses the puzzle maker module. As described above, the user can initiate the puzzle maker module from the home screen of the create and animate studio. Responsive to initiating the puzzle maker module, the user can select to arrange a puzzle with predefined puzzle pieces or the user can select to create a puzzle with custom pieces. In some implementations, the user can select the image that is used for the puzzle. In some implementations, when using the puzzle piece maker, the user can select different options prior to arranging the puzzle pieces such as but not limited to difficulty settings. Once the settings are determined the create and animate studio can shuffle the pieces of the puzzle, which the user can then arrange.

At step 804, the user initiates and uses the free canvas module. The user can initiate the free canvas mode from the create and animate home screen. Using the free canvas module the user can select image backgrounds and then add items to the selected background. The user can add items such as drawings and figures created with the modules described herein and/or images preinstalled with the create and animate studio software. In some implementations, the user can add sound effects in the free canvas module. In yet other implementations, the user can animate the items placed on the canvas. For example, a user can add a super hero image to the background and then add a path to the image such that when the image is animated if moves along the path. In some implementations, the user can export the created canvas image as one or more images or a video.

What is claimed:

1. A method for assisting a user to draw, the method comprising:
providing, by a drawing assistance tool, a reference area that displays a reference image for a user to recreate in a drawing area, a first grid overlaid onto the reference area such that the first grid is independently scalable of the reference image displayed in the reference area, the drawing area that displays a drawing image, and a second grid overlaid onto the drawing area such that the second grid is independently scalable of the drawing area;
receiving a request to scale one of the first grid or the second grid; and
providing the request to scale one of the first grid or the second grid to both the first grid and the second grid.

2. The method of claim 1, further comprising receiving a request to scale one of the reference image or the drawing image.

3. The method of claim 2, wherein the request to scale one of the reference image or the drawing image includes a request to provide at least one of a pan, a rotate, a zoom in, and a zoom out manipulation.

4. The method of claim 2, wherein a plurality of cells of the first grid and a plurality of cells of the second grid maintain a specific size when the reference image or the drawing image is zoomed in or zoomed out.

5. The method of claim 2, further comprising providing the request to scale one of the reference image or the drawing image to both the reference image and the drawing image.

6. The method of claim 1, wherein the request to scale one of the first grid or the second grid includes a request to provide at least one of a pan, a rotate, a zoom in, and a zoom out manipulation.

7. The method of claim 1, further comprising providing a copy of the reference image in the drawing area.

8. The method of claim 7, wherein the copy of the reference image is partially transparent.

9. The method of claim 1, wherein the first grid and second grid are configured to temporally remain fixed in place.

10. The method of claim 1, wherein the reference area and the drawing area are provided on a touch sensitive display.

11. A device for assisted drawing, the device comprising:
a reference area that displays a reference image;
a first grid overlaid onto the reference area such that the first grid is independently scalable of the reference image;
a drawing area that displays a drawing image; and
a second grid overlaid onto the drawing area such that the second grid is independently scalable of the drawing image, and wherein the first grid and the second grid are configured such that when one of the first grid or the second grid is manipulated both the first grid and the second grid are manipulated correspondingly.

12. The device of claim 11, wherein the reference image and the drawing image are configured such that when one of the reference image or the drawing image is manipulated both the reference image and the drawing image are manipulated correspondingly.

13. The device of claim 11, wherein a plurality of cells of the first grid and a plurality of cells of the second grid maintain a specific size when the reference image or the drawing image is zoomed in or zoomed out.

14. The device of claim 11, wherein the manipulation of the first grid or the second grid can include at least one of a pan, a rotate, a zoom in, and a zoom out manipulation.

15. The device of claim 11, further comprising a copy of the reference image displayed in the drawing area.

16. The device of claim 15, wherein the copy of the reference image is partially transparent.

17. The device of claim 15, wherein the copy of the reference image maintains a location in the drawing area that is a same location the reference image maintains in the reference area.

18. The device of claim 11, wherein the first grid is configured to be reversibly locked into the position to the reference area and the second grid is configured to be reversibly locked into position relative to the drawing area.

19. The device of claim 11, further comprising a touch sensitive display.

20. The device of claim 11, where the second grid is configured to have a user selectable transparency level.
